(19) United States
(12) Patent Application Publication
(10) Pub. No.: US 2023/0407044 A1
(43) Pub. Date: Dec. 21, 2023

(54) Polycarbonate Compositions Containing Titanium Dioxide and Metal Oxide-Coated Mica Particles

(71) Applicant: Covestro Deutschland AG, Leverkusen (DE)

(72) Inventors: Rolf Wehrmann, Krefeld (DE); Anke Boumans, Bedburg-Hau (DE); Joerg Reichenauer, Krefeld (DE)

(21) Appl. No.: 18/037,916

(22) PCT Filed: Nov. 18, 2021
(86) PCT No.: PCT/EP2021/082109

§ 371 Date: May 19, 2023

(30) Foreign Application Priority Data
Nov. 23, 2020 (EP) 20209234.2

(51) Int. Cl. C08K 3/22; C08K 9/02

(52) U.S. Cl. CPC C08K 3/22; C08K 9/02; C08K 2003/2241; C08K 2201/005

(57) ABSTRACT

The present disclosure is directed to titanium dioxide-containing, polycarbonate-based thermoplastic compositions that contain metal oxide-containing mica. The metal oxide-containing mica may be provided in very low amounts. The titanium dioxide-containing polycarbonate-based thermoplastic compositions are suitable for reflectors. The addition of mica results in improved reflectance values as compared to the same mixtures without mica component.

### CROSS-REFERENCE TO RELATED APPLICATIONS

This application is the United States national phase of International Application No. PCT/EP2021/082109 filed Nov. 18, 2021, and claims priority to European Patent Application No. 20209234.2 filed Nov. 23, 2020, the disclosures of which are hereby incorporated by reference in their entireties.

### BACKGROUND OF THE INVENTION

### Field of the Invention

The present invention provides titanium dioxide-containing polycarbonate-based compositions having high reflectance. The invention further relates to improving the reflectance. The present invention further relates to molded parts composed of these compositions, for instance for housings/housing parts or other elements in the electricals and electronics and IT sectors, for example for trim pieces and switches for automotive interior illumination and in particular for reflectors of illumination units such as LED lamps or LED arrays and automotive headlights and taillights or indicators.

### Description of Related Art

It is known from the prior art to add titanium dioxide to plastics such as polycarbonate to improve reflectance.

CN 109867941 A for instance describes a reflective polycarbonate material containing titanium dioxide, a liquid silicone and further polymeric constituents.

TW 200743656 A discloses flame-retardant, halogen-free, reflective polycarbonate compositions which, in addition to titanium dioxide, contain inorganic fillers such as clay or silica and further organic components such as optical brighteners, perfluoroalkylene compounds and metal salts of aromatic sulfur compounds.

The reflectance values achieved with conventional compositions are increasingly failing to meet market expectations. For components such as reflectors for example there is a demand for compositions having ever higher reflectance to utilize the employed energy as well as possible.

However, large amounts of titanium dioxide are required to achieve high reflectance values. This is disadvantageous since titanium dioxide can lead to decomposition of the polycarbonate matrix, thus potentially leading to melt instabilities and a reduction in the viscosity of the compound, as a result of which thermal and mechanical properties are also impaired.

The amount of titanium dioxide also has a marked effect on the cost of the polycarbonate compositions and it is therefore desirable to increase reflectance through measures other than addition of ever greater amounts of titanium dioxide.

Optical brighteners that could be added in turn have the disadvantage that their use results in a nonlinear reflectance curve which can lead to a blue tint of the material which is considered disruptive.

### SUMMARY OF THE INVENTION

It is accordingly an object of the present invention to provide titanium dioxide-containing, polycarbonate-based compositions having improved reflectance and corresponding molded parts made of these compositions, wherein in addition to improved reflectance the compositions preferably should not exhibit significantly poorer flow behavior during processing and/or should also lack disruptive tints.

It has surprisingly been found that titanium dioxide-containing compositions based on polycarbonate exhibit elevated reflectances when they contain a very low concentration of metal oxide-coated mica particles. If the mica is employed as an interference/pearlescent pigment, a so-called effect pigment, it is customary to add a few percent by weight thereof based on the composition. For example WO 2018/197572 A1 refers to an amount of 0.8% to 3.0% by weight and WO 2019/224151 A1 to an amount of 0.8% to ≤5.0% by weight. JP 2005015657 A, JP 2010138412 A and JP 2005015659 A likewise describe polycarbonate-based titanium dioxide-containing compositions which may be admixed with an inorganic filler, such as mica. The usage amount is 0.5 to 15 parts by weight based on 100 parts by weight of polycarbonate and this is said to ensure good dimensional stability. These documents contain no reference to mica providing an improvement in reflectance.

According to the invention, surprising enhancement of reflectance can thus be achieved using mica, even in amounts significantly lower than those in which metal oxide-coated mica is typically employed as an effect pigment, which is the conventional application. The concentration of the metal oxide-coated mica particles is then sufficiently low to ensure that their character of acting as an effect pigment does not become visually apparent and the brilliant white color impression of the injection molded articles is retained unaltered. The flow behavior of the compositions is not significantly affected here and the good processability in injection molding is retained.

### DETAILED DESCRIPTION

Thermoplastic compositions according to the invention are therefore those comprising
A) 44% by weight to 96.999% by weight of aromatic polycarbonate,
B) 3.0% by weight to 30.0% by weight of titanium dioxide and
C) metal oxide-coated mica,
   characterized in that
   the amount of component C is 0.001% by weight to 0.15% by weight,
   wherein the reported amounts are in each case based on the total weight of the thermoplastic composition.

The reported % by weight values below are also in each case based on the total weight of the thermoplastic composition unless otherwise stated.

Thermoplastic compositions preferred according to the invention contain
A) 44.9% by weight to 95.996% by weight of aromatic polycarbonate,
B) 4.0% by weight to 25% by weight of titanium dioxide and
C) 0.004% by weight to 0.1% by weight of metal oxide-coated mica,
   wherein the reported amounts are in each case based on the total weight of the thermoplastic composition.

The compositions according to the invention may in principle also contain one or more blend partners. Examples of thermoplastic polymers suitable as blend partners are polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates, poly- or copolymethacrylate, for example poly- or copolymethylmethacrylates (such as PMMA), and also copolymers with styrene, for example transparent polystyrene-acrylonitrile (PSAN), thermoplastic polyurethanes and/or polymers based on cyclic olefins (e.g. TOPAS®, a commercial product from Ticona).

More preferred thermoplastic compositions consist of
A) 44.9% by weight to 95.996% by weight of aromatic polycarbonate,
B) 4.0% by weight to 25% by weight of titanium dioxide and
C) 0.004% by weight to 0.1% by weight of metal oxide-coated mica,
D) 0% to 30% by weight of one or more further additives(s) distinct from components B and C,
E) optionally one or more blend partners,
wherein the reported amounts are in each case based on the total weight of the thermoplastic composition.

Yet more preferred thermoplastic compositions consist of
A) 44.9% by weight to 95.996% by weight of aromatic polycarbonate,
B) 4.0% by weight to 25% by weight of titanium dioxide and
C) 0.004% by weight to 0.1% by weight of metal oxide-coated mica,
D) 0% to 30% by weight of one or more further additives(s) distinct from components B and C,
wherein the reported amounts are in each case based on the total weight of the thermoplastic composition.

Thermoplastic compositions particularly preferred according to the invention consist of
A) 64.9% by weight to 95.996% by weight of aromatic polycarbonate,
B) 4.0% by weight to 25% by weight of titanium dioxide and
C) 0.004% by weight to 0.1% by weight of metal oxide-coated mica,
D) 0% to 10% by weight of one or more further additives(s) distinct from components B and C,
   wherein the reported amounts are in each case based on the total weight of the thermoplastic composition.

Thermoplastic compositions very particularly preferred according to the invention consist of
A) 76.99% by weight to 94.994% by weight, in particular 76.99% by weight to 94.993% by weight, of aromatic polycarbonate,
B) 5% by weight to 20% by weight of titanium dioxide and
C) 0.006% by weight to 0.010% by weight of metal oxide-coated mica,
D) 0% to 3% by weight, in particular 0.01% to 3% by weight, of one or more further additive(s) distinct from components B and C,
   wherein the reported amounts are in each case based on the total weight of the thermoplastic composition.

In the context of the present invention—unless explicitly stated otherwise—the stated % by weight values for components A, B, C and optionally D are in case based on the total weight of the composition. It will be appreciated that all of the components present in the composition according to the invention, i.e. the amounts of the components A, B, C, optionally D, optionally further components such as E, sum to 100% by weight. In addition to the components A, B, C, optionally D, the composition may in principle contain further components provided the abovementioned core properties of the compositions according to the invention are retained. The compositions may accordingly contain one or more further thermoplastics not covered by any of the components A to D as blend partners. However, it is very particularly preferable when the above-described compositions contain no further components but rather the amounts of the components A, B, C and optionally D, especially in the described preferred embodiments, sum to 100% by weight, i.e. the compositions consist of the components A, B, C, optionally D.

It will be appreciated that the employed components may contain typical impurities arising from their production processes for example. It is preferable to use the purest possible components. It will further be appreciated that these impurities may also be present in the event of an exhaustive formulation of the composition. The impurities are part of the total weight of the respective component.

The present invention also provides for improving the reflectance, preferably determined according to ASTM E 1331-2015 at a layer thickness of 2 mm, of titanium dioxide-containing polycarbonate compositions through addition of metal oxide-coated mica particles. The improvement in reflectance relates to the corresponding compositions without metal oxide-coated mica particles. “Improving reflectance” is to be understood as meaning any increase in the reflectance value whatsoever.

It is also preferable to additionally achieve an improvement in yellowness index, more preferably determined according to ASTM E 313-15 (observer 10°/illuminant: D65) on specimen sheets having a layer thickness of 2 mm . Here too, the reference is the same as that described above. “An improvement in yellowness index” is to be understood as meaning any reduction in yellowness index.

It will be appreciated that the features recited as preferred for the composition according to the invention also apply in respect of the use according to the invention.

The compositions whose reflectance is further improved through addition of component C have a reflectance before addition of component C of preferably at least 95%, particularly preferably at least 96%, determined according to ASTM E 1331-2015 at a layer thickness of 2 mm.

The individual constituents of the compositions according to the invention are more particularly elucidated hereinbelow:

### Component A

“Aromatic polycarbonate” or just “polycarbonate” in the context of the present invention is to be understood as meaning both aromatic homopolycarbonates and aromatic copolycarbonates. These polycarbonates may be linear or branched in the familiar manner. According to the invention, it is also possible to use mixtures of polycarbonates.

Compositions according to the invention contain as component A at least 44% by weight, preferably at least 44.9% by weight, more preferably at least 64.9% by weight, yet more preferably at least 76.99% by weight, of aromatic polycarbonate. According to the invention a proportion of at least 44% by weight, preferably at least 64.9% by weight, of aromatic polycarbonate in the total composition means that the composition is based on aromatic polycarbonate. A single polycarbonate or a mixture of two or more polycarbonates may be present.

The polycarbonates present in the compositions are produced in a known manner from dihydroxyaryl compounds, carbonic acid derivatives, and optionally chain terminators and branching agents.

Details of the production of polycarbonates have been set out in many patent specifications over the past years or so. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and lastly to U. Grigo, K. Kirchner and P.R. Müller “Polycarbonate” [Polycarbonates] in Becker/Braun, Kunststoff-Handbuch [Plastics Handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117 to 299.

Aromatic polycarbonates are produced, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

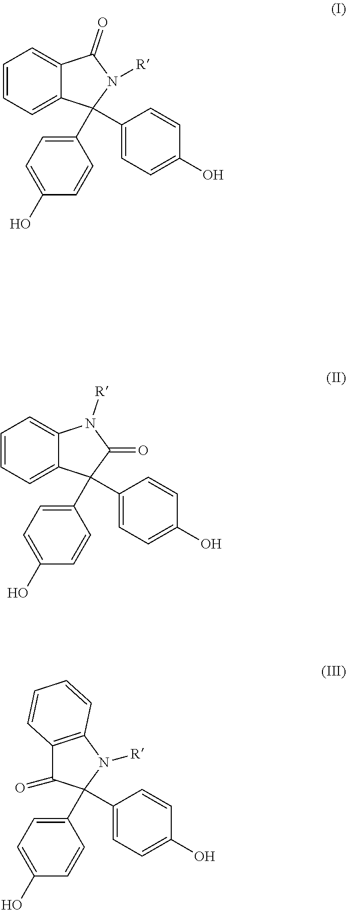

in which each R′ is C₁-to C₄-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,365 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are phenols which are mono or polysubstituted with linear or branched, preferably unsubstituted C₁ to C₃₀ alkyl radicals or with tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and/or (III)

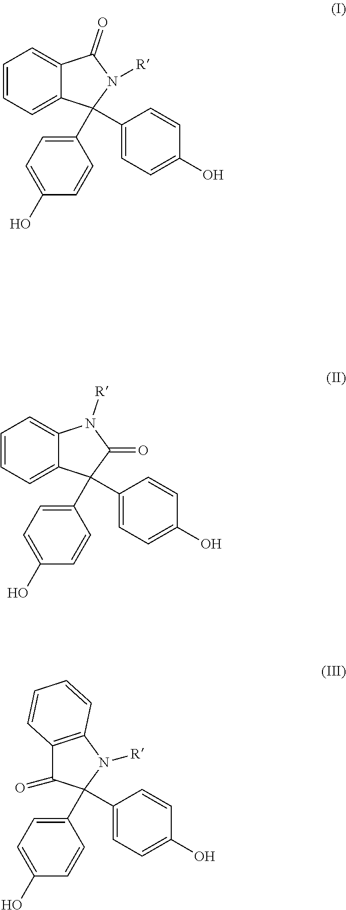

in which each R′ is C₁-to C₄-alkyl, aralkyl or aryl, preferably methyl or phenyl, very particularly preferably methyl,
   in particular with bisphenol A.
   Also preferred are copolycarbonates produced using diphenols of general formula (1a):

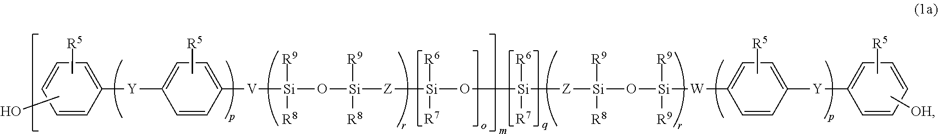

wherein
R⁵ represents hydrogen or C₁-to C₄-alkyl, C₁-to C₃-alkoxy, preferably hydrogen, methoxy or methyl,
R⁶, R⁷, R⁸ and R⁹ each independently of one another represent C₁-C₄-alkyl or C₆-C₁₂-aryl, preferably methyl or phenyl,
Y represents a single bond, SO₂—, —S—, —CO—, —O—, C₁-to C₆-alkylene, C₂-to C₅-alkylidene, C₆-to C₁₂-arylene which may optionally be fused to further aromatic rings containing heteroatoms or represents a C₅-to C₆-cycloalkylidene radical which may be mono- or polysubstituted with C₁-bis C₄-alkyl, preferably represents a single bond, —O—, isopropylidene or a C₅-to C₆-cycloalkylidene radical which may be mono- or polysubstituted with C₁-to C₄-alkyl,
V represents oxygen, C₂-to C₆-alkylene or C₃-to C₆-alkylidene, preferably oxygen or C₃-alkylene,
p, q and r are each independently 0 or 1,
when q=0, W represents a single bond, when q=1 and r=0, W represents oxygen, C₂-to C₆-alkylene or C₃-to C₆-alkylidene, preferably oxygen or C₃-alkylene,
when q=1 and r=1, W and V each independently represent C₂-to C₆-alkylene or C₃-to C₆-alkylidene, preferably C₃-alkylene,
Z represents a C₁-to C₆-alkylene, preferably C₂-alkylene,
o represents an average number of repeating units from 10 to 500, preferably 10 to 100, and
m is an average number of repeat units from 1 to 10, preferably 1 to 6, more preferably 1.5 to 5. It is likewise possible to use to the diphenols in which two or more siloxane blocks of general formula (1a) are bonded to one another via terephthalic acid and/or isophthalic acid to form ester groups.
Especial preference is given to (poly)siloxanes of formulae (2) and (3)

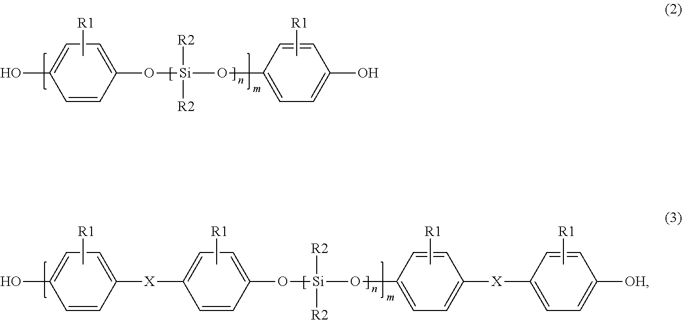

wherein R1 represents hydrogen, C₁-to C₄-alkyl, preferably hydrogen or methyl and especially preferably hydrogen,
R2 independently at each occurrence represents aryl or alkyl, preferably methyl,
X represents a single bond, —SO₂—, —CO—, —O—, —S—, C₁-to C₆-alkylene, C₂-to C₅-alkylidene or C₆-to C₁₂-arylene which may optionally be fused to further aromatic rings containing heteroatoms,
X preferably represents a single bond, C₁-to C₅-alkylene, C₂-to C₅-alkylidene, C₅-bis C₁₂-cycloalkylidene, —O—, —SO— —CO—, —S—, —SO₂—, particularly preferably a single bond, isopropylidene, C₅-to C₁₂-cycloalkylidene or oxygen and very particularly preferably isopropylidene,
n represents an average number from 10 to 400, preferably 10 to 100, especially preferably 15 to 50 and
m represents an average number from 1 to 10, preferably from 1 to 6 and especially preferably from 1.5 to 5.
The siloxane block may similarly preferably be derived from the following structure

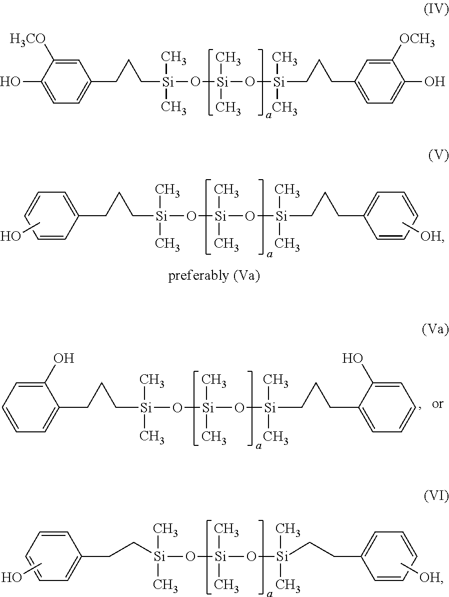

wherein a in formulae (IV), (V) and (VI) represents an average number of 10 to 400, preferably 10 to 100 and particularly preferably 15 to 50.
It is likewise preferable when at least two identical or different siloxane blocks of general formulae (IV), (V) or (VI) are bonded to one another via terephthalic acid and/or isophthalic acid to form ester groups.

It is likewise preferable when in formula (1a) p=0 ist, V represents C₃-alkylene, r=1, Z represents C₂-alkylene, R⁸ and R⁹ represent methyl, q=1, W represents C₃-alkylene, m=1 ist, R⁵ represents hydrogen or C₁-to C₄-alkyl, preferably hydrogen or methyl, R⁶ and R⁷ each independently of one another represent C₁-to C₄-alkyl, preferably methyl, and o is 10 to 500.

Copolycarbonates having monomer units of formula (1a) and in particular also the production thereof are described in WO 2015/052106 A2.

The thermoplastic polycarbonates, including the thermoplastic aromatic polyester carbonates, preferably have weight-average molecular weights M_{w} of 15 000 to 40 000 g/mol, more preferably to 34 000 g/mol, particularly preferably of 17 000 to 33 000 g/mol, in particular of 19 000 to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm Particle sizes of column material: 3 μm to 20 μm. Concentration of solutions: 0.2% by weight. Flow rate: 1.0 ml/min, temperature of solutions: 30° C. Use of UV and/or RI detection.

To achieve incorporation of additives, component A is preferably employed in the form of powders, pellets or mixtures of powders and pellets.

### Component B

Compositions according to the invention contain 3.0% by weight to 30.0% by weight, preferably 4.0% by weight to 25% by weight, particularly preferably 5% by weight to 20% by weight, very particularly preferably 5.0% to 20.0% by weight, of titanium dioxide.

The titanium dioxide of component B of the compositions according to the invention preferably has an average particle size D₅₀, determined by scanning electron microscopy (STEM), of 0.1 to 5 μm, preferably 0.2 μm to 0.5 μm However, the titanium dioxide may also have a different particle size, for example an average particle size D₅₀, determined by scanning electron microscopy (STEM), of ≥0.5 μm, for instance 0.65 μm to 1.15 μm.

The titanium dioxide preferably has a rutile structure.

The titanium dioxide used in accordance with the invention is a white pigment, Ti(IV)O₂. Colored titanium dioxides contain not only titanium but also elements such as Sb, Ni, Cr in significant amounts, so as to result in a color impression other than “white”. It will be appreciated that traces of other elements may also be present as impurities in the titanium dioxide white pigment. However, these amounts are so small that the titanium dioxide does not take on any tint as a result.

Suitable titanium dioxides are preferably those produced by the chloride process, hydrophobized, specially aftertreated and suitable for use in polycarbonate. Instead of sized titanium dioxide, compositions according to the invention may in principle also employ unsized titanium dioxide or a mixture of both. However, the use of sized titanium dioxide is preferred.

Possible surface modifications of titanium dioxide include inorganic and organic modifications. These include for example aluminum- or polysiloxane-based surface modifications. An inorganic coating may contain 0.0% to 5.0% by weight of silicon dioxide and/or aluminum oxide. An organic-based modification may contain 0.0% by weight to 3.0% by weight of a hydrophobic wetting agent. The titanium dioxide preferably has an oil absorption number determined according to DIN EN ISO 787-5:1995-10, of 12 to 18 g/100 g of titanium dioxide, more preferably of 13 to 17 g/100 g of titanium dioxide, particularly preferably of 13.5 to 15.5 g/100 g of titanium dioxide.

Particular preference is given to titanium dioxide having the standard designation R2 according to DIN EN ISO 591-1:2001-08, which is stabilized with aluminum and/or silicon compounds and has a titanium dioxide content of at least 96.0% by weight. Such titanium dioxides are available under the brand names Kronos 2233 and Kronos 2230.

### Component C

Component C of the compositions according to the invention is metal oxide-coated mica. The employed mica is in particulate form.

This is preferably an interference and/or pearlescent pigment from the group of metal oxide-coated mica.

The mica may be naturally occurring or synthetically produced mica, wherein the latter is preferred on account of the typically higher purity. Mica obtained from natural sources is typically accompanied by further minerals. The mica is preferably muscovite-based, i.e. it preferably comprises at least 60% by weight, more preferably at least 70% by weight, yet more preferably at least 85% by weight, particularly preferably at least 90% by weight, of muscovite based on the total weight of the mica content without the metal oxide coating.

The metal oxide coating preferably comprises one or more coating layers containing titanium dioxide, tin oxide, aluminum oxide and/or iron oxide, wherein the metal oxide is more preferably iron(III) oxide (Fe₂O₃), iron(II, III) oxide (Fe₃O₄, a mixture of Fe₂O₃ and FeO) and/or titanium dioxide, particularly preferably titanium dioxide. The metal oxide coating is thus very particularly preferably a titanium dioxide coating.

The proportion of titanium dioxide in the total weight of component C is preferably 20% to 60% by weight, yet more preferably 25% to 50% by weight, and the proportion of mica is preferably 40% to 80% by weight, yet more preferably 50% to 75% by weight.

Preferred titanium dioxides are rutile and/or anatase. It is preferable when at least 90% by weight, more preferably at least 95% by weight, yet more preferably at least 98% by weight, of component C is anatase and/or rutile-coated mica.

To increase compatibility with the polymer matrix of polycarbonate the mica is preferably additionally provided with a silicate coating, in particular a sol-gel coating. According to the invention a silicate coating is especially also to be understood as meaning a coating of silicon dioxide. This typically increases both the weathering resistance and the chemicals resistance of the mica.

The average particle size (D50) of component C, determined by laser diffractometry on an aqueous slurry of component C, is preferably between 1 and 100 μm, in the case of synthetic mica more preferably between to 80 μm and in the case of natural mica more preferably between 3 and 30 μm, in the case of mica generally particularly preferably between 3.5 to 25 μm, very particularly preferably 4.0 to 22 μm. The D90 value, likewise determined by laser diffractometry on an aqueous slurry of component C, is in the case of synthetic mica preferably from 10 to 150 μm and in the case of natural mica preferably from 5 to 80 μm. The density of the pigment is preferably 2.5 to 5.0 g/cm³, more preferably 2.8 to 4.0 g/cm³, particularly preferably from 3.0 to 3.4 g/cm³, determined according to DIN EN ISO 1183-1:2013-04.

Such metal oxide-coated micas, which are conventionally employed as pearlescent and/or interference pigments, are obtainable inter alia from BASF SE under the names “Magnapearl” or “Mearlin Magnapearl” or from Merck SE under the names “Iriodin” or “Candurin”.

The proportion of the at least one metal oxide-coated mica in the total polycarbonate-based composition is by weight to 0.15% by weight, preferably 0.004% to 0.1% by weight, more preferably to 0.10% by weight, yet more preferably 0.005% to 0.02% by weight, particularly preferably 0.006% by weight to by weight.

### Component D

Optionally also present in addition are further additives preferably in amounts of up to 30% by weight, more preferably up to 10.0% by weight, yet more preferably 0.01% by weight to 6.0% by weight, particularly preferably 0.1% by weight to 3.0% by weight, very particularly preferably 0.2% by weight to 1.0% by weight, in particular up to 0.5% by weight of other customary additives (“further additives”). The group of further additives does not include titanium dioxide since this has been described above as component B. The group of further additives likewise does not include mica of component C.

Such further additives, such as are typically added to polycarbonates, include in particular heat stabilizers, flame retardants, antioxidants, mold release agents, anti-drip agents, for instance polytetrafluoroethylene (Teflon) or SAN-encapsulated PTFE (e.g. Blendex 449), UV absorbers, IR absorbers, impact modifiers, antistats, optical brighteners, fillers distinct from component B, for example talc, silicates or quartz, light scattering agents, hydrolysis stabilizers, compatibilizers, organic colorants, organic pigments, inorganic pigments that are distinct from component B and/or additives for laser marking, especially in the amounts customary for polycarbonate-based compositions. Such additives are described for example in EP-A 0 839 623 , WO-A 96/15102, EP-A 0 500 496 or in “Plastics Additives Handbook”, Hans Zweifel, 5th Edition 2000, Hanser Verlag, Munich. These additives may be added individually or else as mixtures. It will be appreciated that it is only permissible to add such additives in such amounts that do not have a significant adverse impact on the inventive effect of improved reflectance. Carbon black, for example, is preferably not included. An improvement in reflectance relative to corresponding reference compositions that differ from the composition according to the invention only in that they do not contain any mica of component C must also be observed.

The additives are preferably selected from the group consisting of heat stabilizers, flame retardants, antioxidants, mold release agents, anti-drip agents, UV absorbers, IR absorbers, impact modifiers, antistats, optical brighteners, fillers distinct from component B, light scattering agents, organic colorants, organic pigments, inorganic pigments that are distinct from component B, hydrolysis stabilizers, transesterification inhibitors, compatibilizers and/or additives for laser marking If additives are present one or more of these additives may represent component D in a composition according to the invention.

The further additives are particularly preferably those selected from the group consisting of flame retardants, anti-drip agents, UV absorbers, heat stabilizers, antioxidants, antistats, mold release agents, impact modifiers, colorants, transesterification inhibitors.

The compositions more preferably contain at least one flame retardant selected from the group of alkali metal, alkaline earth metal or ammonium salts of aliphatic/aromatic sulfonic acid, sulfonamide and sulfonimide derivatives or else combinations thereof.

According to the invention, “derivatives” is here and elsewhere to be understood as meaning compounds where the molecular structure has a different atom or a different group of atoms in place of an H-atom or a functional group or where one or more atoms/group of atoms have been removed. The parent compound thus remains recognizable.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl) benzenesulfonamide, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany.

The amounts of alkali metal, alkaline earth metal and/or ammonium salts of aliphatic/aromatic sulfonic acid, sulfonamide and sulfonimide derivatives in the composition, if employed, preferably sum to 0.05% by weight to 0.5% by weight, more preferably 0.06% by weight to 0.3% by weight, particularly preferably 0.06% by weight to 0.2% by weight, particularly preferably 0.065% by weight to 0.12% by weight.

Additionally or alternatively present preferred additives are heat stabilizers.

Suitable heat stabilizers are in particular phosphorus-based stabilizers selected from the group of the phosphates, phosphites, phosphonites, phosphines and mixtures thereof. It is also possible to use mixtures of different compounds from one of these subgroups, for example two phosphites.

Heat stabilizers preferably used are phosphorus compounds having the oxidation number +III, in particular phosphines and/or phosphites.

Particularly preferably suitable heat stabilizers are triphenylphosphine, tris(2,4-di-tert-butylphenyl) phosphite (Irgafos® 168), tetrakis(2,4-di-tert-butylphenyl)-[1,1-biphenyl]-4,4′-diylbisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36).

They may be employed alone or in admixture, for example Irganox® B900 (mixture of Irgafos® 168 and Irganox® 1076 in a 4:1 ratio) or Doverphos® S-9228 with Irganox® B900/Irganox® 1076.

The heat stabilizers are preferably employed in amounts of up to 1.0% by weight, more preferably 0.003% by weight to 1.0% by weight, yet more preferably 0.005% to 0.5% by weight, particularly preferably 0.01% to 0.2% by weight.

Preferably additives also include specific UV stabilizers having a lowest possible transmittance below 400 nm and a highest possible transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′, 5′-bis(1,1-dimethylbenzyl)-2′-hydroxyphenyl)benzotriazole (Tinuvin ® 234, BASF SE, Ludwigshafen), 2-(2′-hydroxy-5′-(tert-octyl) phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), 2-(5-chloro-2H-benzotriazol-2-yl)-6-(1,1-dimethylethyl)-4-methylphenol (Tinuvin® 326, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)oxy]methyl]-1,3-propanediyl ester (9CI) (Uvinul 3030, BASF SE Ludwigshafen), 2-[2-hydroxy-4-(2-ethylhexyl) oxy]phenyl-4,6-di(4-phenyl)phenyl-1,3,5-triazine (Tinuvin 1600, BASF SE, Ludwigshafen), tetraethyl 2,2′-(1,4-phenylenedimethylidene)bismalonate (Hostavin B-Cap, Clariant AG) or N-(2-ethoxyphenyl)-N′-(2-ethylphenyl)ethanediamide (Tinuvin 312, CAS no. 23949-66-8, BASF SE, Ludwigshafen).

Particularly preferred specific UV stabilizers are Tinuvin 360, Tinuvin 329, Tinuvin 326, Tinuvin 1600, Tinuvin 312, Uvinul 3030 and/or Hostavin B-Cap, very partiularly preferably Tinuvin 329 and Tinuvin 360.

It is also possible to use mixtures of the abovementioned ultraviolet absorbers.

If UV absorbers are present, the composition preferably contains ultraviolet absorbers in an amount of up to 0.8% by weight, preferably 0.05% by weight to 0.5% by weight, more preferably 0.08% by weight to by weight, very particularly preferably 0.1% by weight 0.35% by weight, based on the overall composition.

The compositions according to the invention may also comprise phosphates or sulphonate esters as transesterification inhibitors. A preferably present transesterification inhibitor is triisooctyl phosphate. Triisooctyl phosphate is preferably used in amounts of 0.003% by weight to 0.05% by weight, more preferably by weight to 0.04% by weight and particularly preferably of 0.01% by weight to 0.03% by weight, based on the total composition.

Examples of impact modifiers suitable as additives include: acrylate core-shell systems such as ABS or MBS or butadiene rubbers (Paraloid series from DOW Chemical Company); olefin-acrylate copolymers, for example the Elvaloy® series from DuPont; silicone acrylate rubbers, for example the Metablen® series from Mitsubishi Rayon Co., Ltd.

At least one additive selected from the group consisting of heat stabilizers, mold release agents, antioxidants, impact modifiers, flame retardants and anti-drip agents is very particularly preferably present, in particular in an amount of 0% to 3% by weight. Mixtures of two or more of the aforementioned additives may also be present.

The compositions according to the invention are preferably free from optical brighteners.

It is exceptionally preferred when the compositions according to the invention contain at least one additive from the group consisting of heat stabilizers, flame retardant and impact modifiers. Additional additives from the group of further additives of component D may also be present but need not be.

As a further additive at least one anti-drip agent may be present, preferably in an amount of 0.05% by weight to 1.5% by weight, in particular 0.1% by weight to 1.0% by weight.

The production of the compositions according to the invention comprising components A to C and optionally D and optionally blend partners is effected by commonly used incorporation processes by combination, mixing and homogenization of the individual constituents, wherein in particular the homogenization preferably takes place in the melt under the influence of shear forces. Combination and mixing is optionally effected prior to melt homogenization using powder pre-mixes.

It is also possible to use premixes of pellets, or of pellets and powders, with components B, C and optionally D, with the polycarbonate or else with the optionally present blend partners.

It is also possible to use pre-mixes produced from solutions of the mixture components in suitable solvents where homogenization is optionally effected in solution and the solvent is then removed.

In particular, the components of the composition according to the invention may be introduced into the polycarbonate, optionally into the polycarbonate with blend partners, by known methods or as a masterbatch.

The use of masterbatches to incorporate the components B to D—individually or as mixtures—is preferable.

In this connection, the composition according to the invention can be combined, mixed, homogenized and subsequently extruded in customary apparatuses such as screw extruders (ZSK twin-screw extruders for example), kneaders or Brabender or Banbury mills. The extrudate may be cooled and comminuted after extrusion. It is also possible to premix individual components and then to add the remaining starting materials individually and/or likewise mixed.

The combining and mixing of a pre-mix in the melt may also be effected in the plasticizing unit of an injection molding machine. In this case, the melt is directly converted into a molded article in the subsequent step.

The compositions according to the invention preferably have a melt volume flow rate (MVR) of 3 to 40 cm³/(10 min), more preferably of 6 to 30 cm³/(10 min), yet more preferably of 8 to 25 cm³/(10 min), determined according to ISO 1133:2012-3 (test temperature 300° C., mass 1.2 kg). The compositions according to the invention are preferably used for producing molded parts.

Production of the molded parts is preferably effected by injection molding, extrusion or from solution in a casting process. The compositions according to the invention can be processed in a customary manner in standard machines, for example in extruders or injection molding machines, to give any molded articles, for example films, sheets or bottles.

The compositions/molded parts made of the compositions appear “brilliant white” to the observer. The compositions according to the invention are suitable for producing multilayered systems. The polycarbonate-containing composition is applied in one or more layers to a molded article made of a plastic or itself serves as a substrate layer upon which one or more further layers are applied. Application may be carried out at the same time as or immediately after the molding of the molded article, for example by in-mold coating of a film, coextrusion or multicomponent injection molding. However, application can also take place onto the finished molded main body, for example by lamination with a film, insert molding of an existing molded article or by coating from a solution.

The compositions according to the invention are suitable for production of components in the lighting sector, for instance reflectors of lamps, in particular LED lamps or LED arrays, in the automotive sector, for instance headlight and taillight reflectors, of parts for indicators, trim pieces, switches or bezels and for producing bezels or bezel parts or housings or housing parts in the electricals and electronics and IT sectors. On account of the very good reflectance values the compositions according to the invention are preferably used for producing reflectors. These and other molded parts consisting of the compositions according to the invention or, for example in the case of multicomponent injection molding, comprising these, including molded parts constituting a layer of a multilayered system or layers of multilayered systems or an element of an abovementioned component or such a component as a whole and made of (“consisting of”) these compositions according to the invention, likewise form part of the subject matter of the present application. The compositions according to the invention are also employable as a 3D printing material in the form of filaments, as pellets or powder.

The embodiments described hereinabove for the compositions according to the invention also pertain—if applicable—to the use according to the invention of component C.

This is the use of metal oxide-coated mica for improving the reflectance of titanium dioxide-containing polycarbonate compositions, wherein reflectance is preferably determined according to ASTM E 1331-2015 at a layer thickness of 2 mm, and the use of metal oxide-coated mica for improving yellowness index, preferably determined according to ASTM E 313-15 (observer 10°/illuminant: D65) on specimen sheets having a layer thickness of 2 mm, wherein both objectives may be separate or combined with one another.

The examples which follow are intended to illustrate the invention but without limiting said invention.

### EXAMPLES

### 1. Description of Raw Materials and Test Methods

The polycarbonate compositions described in the following examples were produced on a Berstorff ZE 25 extruder at a throughput of 10 kg/h by compounding. The melt temperature was 275° C.

Component A1: Linear polycarbonate based on bisphenol A having a melt volume-flow rate MVR of 19 cm³/(10 min) (according to ISO 1133:2012-03, at a test temperature of 300° C. and under a load of 1.2 kg). The product contains 250 ppm of triphenylphosphine as component D2.
Component A2: Linear polycarbonate based on bisphenol A in powder form having a melt volume-flow rate MVR of 19 cm³/(10 min) (according to ISO 1133:2012-03, at a test temperature of 300° C. and under a load of 1.2 kg).
Component B: Kronos 2230 titanium dioxide from Kronos Titan GmbH, Leverkusen.
Component C1: Mearlin Magnapearl 3000 anatase-coated mica from BASF SE, Ludwigshafen. This consisted of a mica coated with titanium dioxide. X-ray powder diffractometry was used to determine muscovite as the relevant mica mineral. The ratio of the two components was determined as 56% mica and 44% anatase. The D50 value was determined as 5.7 μm using a Malvern Mastersizer.
Component C2: Merlin Magnapearl 1000 titanium dioxide-coated mica from BASF SE, Ludwigshafen. This consisted of a mica coated with titanium dioxide. X-ray powder diffractometry was used to determine muscovite as the relevant mica mineral. The ratio of the two components was determined as 72% mica and 28% anatase. The D50 value was determined as 19 μm using a Malvern Mastersizer.
Component D1: Aluminum oxide AP10 inorganic filler, commercially available from Dreyplas GmbH.
Component D2: Triphenylphosphine, commercially available from BASF SE, Ludwigshafen.
Component D3: Paraloid EXL2300 from Dow. Acrylic core/shell impact modifier based on butyl acrylate-rubber.
Melt volume flow rate (MVR) was determined according to ISO 1133:2012-03 (at a testing temperature of 300° C., mass 1.2 kg) using a Zwick 4106 instrument from Zwick Roell. MVR was also measured after a preheating time of 20 minutes (IMVR20′). This is a measure of melt stability under elevated thermal stress.

Determination of ash content was carried out according to DIN 51903:2012-11 (850° C., hold for 30 min).

The total reflectance spectrum was measured on the basis of the standard ASTM E 1331-04 using a spectrophotometer. The total transmittance spectrum was measured on the basis of the standard ASTM E 1348-15 using a spectrophotometer. The layer thickness was 2 mm.

The transmittance or reflectance spectrum thus obtained was used to calculate visual transmittance Ty (illuminant D65, observer 10°) or visual reflectance Ry (illuminant D65, observer 10°) in each case according to ASTM E 308-08. This also applies to the color values L*a*b*.

Shine was determined according to ASTM D 523-14.

Yellowness Index (Y.I.) was determined according to ASTM E 313-10 (Observer: 10°/illuminant: D65) at a layer thickness of 2 mm.

In the following table the inventive experiments are labeled “E” and the comparative examples are labelled “V”.

TABLE 1

| Example | | | V-1 | E-2 | E-3 | E-4 | V-5 | V-6 |
|---|---|---|---|---|---|---|---|---|
| Component | | | % by wt | % by wt | % by wt | % by wt | % by wt | % by wt |
| A1 | | | 80.00 | 80.000 | 80.000 | 80.000 | 80.000 | 80.00 |
| A2 | | | 8.00 | 7.994 | 7.992 | 7.990 | 7.500 | 7.00 |
| B | | | 12.00 | 12.000 | 12.000 | 12.000 | 12.000 | 12.00 |
| C1 | | | | 0.006 | 0.008 | 0.010 | 0.500 | 1.00 |
| Test | Condition/Standard | Unit | | | | | | |
| MVR | 300° C.; 1.20 kg; 7 min | cm³/[10min] | 20.5 | 19.7 | 20.1 | 20.6 | 21.6 | 22.4 |
| IMVR20' | 300° C.; 1.20 kg; 20 min | cm³/[10min] | 23.1 | 23.0 | 23.8 | 26.8 | 26.5 | 28.8 |
| ΔMVR/IMVR20' | | | 2.6 | 3.3 | 3.7 | 6.2 | 4.9 | 6.4 |
| Optical data | PELambda950, 0°/180°; | | | | | | | |
| Transmittance | D65; 10° | | | | | | | |
| Sample thickness (ro) | | mm | 1 | 1 | 1 | 1 | 1 | 1 |
| L* (ro) | ASTM E 308 | | 4.93 | 5.44 | 5.58 | 5.93 | 3.05 | 1.88 |
| a* (ro) | ASTM E 308 | | 2.75 | 2.8 | 2.81 | 2.89 | 3.93 | 3.55 |
| b* (ro) | ASTM E 308 | | 6.64 | 7.32 | 7.41 | 7.91 | 4.78 | 3.09 |
| Transmittance (ro) | | % | 0.54 | 0.6 | 0.62 | 0.66 | 0.34 | 0.21 |
| | Hunter UltraScanPRO, | | | | | | | |
| Reflectance | diffuse/8°; D65; 10° | | | | | | | |
| Sample thickness (ro) | | mm | 2 | 2 | 2 | 2 | 2 | 2 |
| L* (ro) | | | 98.48 | 98.62 | 98.62 | 98.63 | 98.1 | 97.58 |
| a* (ro) | | | −0.64 | −0.63 | −0.63 | −0.63 | −0.37 | −0.21 |
| b* (ro) | | | 1.93 | 1.96 | 1.97 | 1.99 | 2.33 | 2.59 |
| Reflectance (ro) | | % | 96.12 | 96.47 | 96.48 | 96.5 | 95.16 | 93.87 |
| Yellowness index | | | 3.09 | 3.14 | 3.15 | 3.19 | 4.04 | 4.64 |
| (ro) | | | | | | | | |
| 60° Shine (ro) | | | 101 | 101 | 101 | 101 | 93 | 87 |

The addition of small amounts of mica component C1 results in a marked improvement in reflectance (V-1 versus E-2 to E-4). However, an amount of 0.5% by weight of mica component has an opposite effect (V-5): Reflectance is significantly impaired.

TABLE 2

| Example | | | V-7 | E-8 | E-9 | E-10 |
|---|---|---|---|---|---|---|
| Component | | | % by wt | % by wt | % by wt | % by wt |
| A1 | | | 80.00 | 80.000 | 80.000 | 80.000 |
| A2 | | | 6.000 | 5.994 | 5.992 | 5.990 |
| B | | | 12.000 | 12.000 | 12.000 | 12.000 |
| C1 | | | | 0.006 | 0.008 | 0.010 |
| D3 | | | 2.000 | 2.000 | 2.000 | 2.000 |
| Test | Condition | Unit | | | | |
| Ash content | 850° C./0.5 h | % | 11.75 | 12.37 | 12.01 | 11.84 |
| MVR | 300° C.; 1.20 kg; 7 min | cm³/[10min] | 17.3 | 16.1 | 16.7 | 16.9 |
| MVR | 300° C.; 1.20 kg; 20 min | cm³/[10min] | 18.7 | 20.8 | 17.8 | 20.6 |
| ΔMVR/IMVR20' | | | 1.4 | 4.7 | 1.1 | 3.7 |
| Optical data | Hunter UltraScanPRO, | | | | | |
| Transmittance | diffuse/8°; D65; 10° | | | | | |
| Sample thickness | | mm | 1 | 1 | 1 | 1 |
| (ro) | | | | | | |
| L* (ro) | ASTM E 308 | | 3.18 | 3.16 | 3.29 | 3.26 |
| a* (ro) | ASTM E 308 | | 2.96 | 2.88 | 2.89 | 2.92 |
| b* (ro) | ASTM E 308 | | 4.68 | 4.63 | 4.82 | 4.8 |
| Transmittance (ro) | | [%] | 0.35 | 0.35 | 0.36 | 0.36 |
| | Hunter UltraScanPRO, | | | | | |
| Reflectance | diffuse/8°; D65; 10° | | | | | |
| Sample thickness | | mm | 2 | 2 | 2 | 2 |
| (ro) | | | | | | |
| L* (ro) | | | 98.10 | 98.13 | 98.17 | 98.15 |
| a* (ro) | | | −0.53 | −0.53 | −0.53 | −0.53 |
| b* (ro) | | | 1.95 | 1.96 | 1.95 | 1.96 |
| Reflectance (ro) | | % | 95.17 | 95.24 | 95.35 | 95.28 |
| Yellowness index | | | 3.23 | 3.23 | 3.21 | 3.23 |
| (ro) | | | | | | |
| 60° Shine (ro) | | | 100 | 100 | 100 | 99 |

Even with addition of an additive, in this case of the impact modifier of component D3, an improvement in reflectance is detectable through addition of mica component C1.

TABLE 3

| Example | | | V-11 | E-12 | E-13 | V-14 | E-15 | E-16 | E-17 |
|---|---|---|---|---|---|---|---|---|---|
| Component | | | % by wt | % by wt | % by wt | % by wt | % by wt | % by wt | % by wt |
| A1 | | | 87.00 | 87.00 | 87.00 | 72.00 | 72.00 | 72.00 | 72.00 |
| A2 | | | 8.00 | 7.99 | 7.99 | 8.00 | 7.99 | 7.99 | 7.99 |
| B | | | 5.00 | 5.00 | 5.00 | 20.00 | 20.00 | 20.00 | 20.00 |
| C1 | | | | 0.008 | 0.01 | | 0.006 | 0.008 | 0.010 |
| Test | Condition | Unit | | | | | | | |
| Ash content (average) (ro) | 850° C./0.5 h | % | 4.9 | 4.98 | 4.81 | 19.68 | 19.68 | 19.65 | 19.68 |
| MVR | 300° C.; 1.20 kg; 6 min | cm³/[10min] | 18.2 | 19 | 17.1 | 25.7 | 24.3 | 22.7 | 25.1 |
| MVR | 300° C.; 1.20 kg; 19 min | cm³/[10min] | 20.3 | 20.7 | 20.4 | 34.1 | 26.6 | 28.6 | 27.4 |
| ΔMVR/IMVR20' | | | 2.1 | 1.7 | 3.3 | 8.4 | 2.3 | 5.9 | 2.3 |
| Optical data | Hunter UltraScanPRO, | | | | | | | | |
| Reflectance | diffuse/8°; D65; 10° | | | | | | | | |
| Sample thickness (ro) | | mm | 2 | 2 | 2 | 2 | 2 | 2 | 2 |
| L* (ro) | | | 98.2 | 98.27 | 98.25 | 98.45 | 98.51 | 98.49 | 98.5 |
| Reflectance (ro) | | % | 95.42 | 95.60 | 95.54 | 96.05 | 96.19 | 96.15 | 96.16 |
| Yellowness index (ro) | | | 3.49 | 3.62 | 3.64 | 3.36 | 3.38 | 3.35 | 3.38 |
| 60° Shine (ro) | | | 103 | 103 | 103 | 98 | 99 | 98 | 99 |

The same observations as before can also be made with a higher (20% by weight, V-14, E-15 to E-17) or lower (5% by weight, V-11, E-12, E-13) content of titanium dioxide.

TABLE 4

| Example | | | V-18 | E-19 | E-20 | E-21 | V-22 | V-23 |
|---|---|---|---|---|---|---|---|---|
| Component | | | % by wt | % by wt | % by wt | % by wt | % by wt | % by wt |
| A1 | | | 80.000 | 80.000 | 80.000 | 80.000 | 80.000 | 80.000 |
| A2 | | | 8.000 | 7.994 | 7.992 | 7.990 | 7.500 | 7.000 |
| B | | | 12.000 | 12.000 | 12.000 | 12.000 | 12.000 | 12.000 |
| C2 | | | | 0.006 | 0.008 | 0.010 | 0.500 | 1.000 |
| Test | Condition | Standard/Unit | | | | | | |
| Ash content | 850° C./0.5 h | % | 11.88 | 12.04 | 11.96 | 11.93 | 12.53 | 13.07 |
| (average) | | | | | | | | |
| MVR | 300° C.; 1.20 kg; | cm³/[10 min] | 19.6 | 19.9 | 20.5 | 21.2 | 21.1 | 21.5 |
| | 6 min | | | | | | | |
| MVR | 300° C.; 1.20 kg; | cm³/[10 min] | 23.2 | 22.1 | 26.4 | 29.2 | 25.6 | 27.2 |
| | 19 min | | | | | | | |
| Delta | | | 3.6 | 2.2 | 5.9 | 8.0 | 4.5 | 5.7 |
| MVR/IMVR20' | | | | | | | | |
| | PELambda950, | | | | | | | |
| | Photometry | | | | | | | |
| Optical data | sphere 0°/diffuse; | | | | | | | |
| Transmittance | D65; 10° | | | | | | | |
| Sample thickness | | mm | 1 | 1 | 1 | 1 | 1 | 1 |
| (ro) | | | | | | | | |
| L* (ro) | | ASTM E 308 | 4.13 | 4.24 | 4.48 | 3.53 | 1.82 | 0.2 |
| a* (ro) | | ASTM E 308 | 4.47 | 4.38 | 4.32 | 4.53 | 5.49 | 6.24 |
| b* (ro) | | ASTM E 308 | 16.63 | 16.56 | 16.68 | 16.55 | 16.43 | 16.05 |
| Transmittance | | [%] ASTM D | 0.52 | 0.53 | 0.55 | 0.48 | 0.36 | 0.27 |
| (ro) | | 1003/ISO 13468 | | | | | | |
| | Hunter | | | | | | | |
| | UltraScanPRO, | | | | | | | |
| | diffuse/8°; D65; | ASTM E 1331 | | | | | | |
| Reflectance | 10° | with shine | | | | | | |
| Sample thickness | | mm | 2 | 2 | 2 | 2 | 2 | 2 |
| (ro) | | | | | | | | |
| L* (ro) | | | 98.48 | 98.53 | 98.52 | 98.53 | 98.3 | 98.06 |
| a* (ro) | | | −0.62 | −0.63 | −0.63 | −0.63 | −0.56 | −0.5 |
| b* (ro) | | | 2.16 | 2.15 | 2.17 | 2.16 | 2.22 | 2.29 |
| Reflectance (ro) | | % | 96.12 | 96.24 | 96.23 | 96.24 | 95.66 | 95.06 |
| Yellowness index | | | 3.52 | 3.5 | 3.52 | 3.52 | 3.67 | 3.87 |
| (ro) | | | | | | | | |
| 60° Shine (ro) | | | 100 | 100 | 100 | 100 | 91 | 83 |

Reflectance initially increases due to addition of mica component C2 (cf. E-19 to E-21), before decreasing again significantly at higher concentrations (V-22 and V-23).

TABLE 5

| Example | | | V-24 | V-25 | E-26 |
|---|---|---|---|---|---|
| Component | | | % by wt | % by wt | % by wt |
| A1 | | | 80.00 | 80.00 | 80.00 |
| A2 | | | 8.00 | 7.99 | 7.98 |
| B | | | 12.00 | 12.00 | 12.00 |
| C1 | | | | | 0.01 |
| D1 | | | | 0.01 | 0.01 |
| Test | Condition | Standard/Unit | | | |
| Ash content | 850° C./0.5 h | % | 11.54 | 11.47 | 11.68 |
| MVR | 300° C.; 1.20 kg; 7 min | cm³/[10 min] | 21.2 | 21.6 | 21.6 |
| MVR | 300° C.; 1.20 kg; 7 min | cm³/[10 min] | 20.9 | 21.2 | 22 |
| Optical data | | | | | |
| Transmittance | PELambda950, Photometry | | | | |
| | sphere 0°/diffuse; | | | | |
| | D65; 10° | | | | |
| Sample thickness (ro) | | mm | 1 | 1 | 1 |
| L* (ro) | | ASTM E 308 | 4.05 | 3.97 | 4.09 |
| a* (ro) | | ASTM E 308 | 3.24 | 3.17 | 3.2 |
| b* (ro) | | ASTM E 308 | 5.86 | 5.73 | 5.94 |
| Transmittance (ro) | | [%] ASTM D 1003/ | 0.45 | 0.44 | 0.45 |
| | | ISO 13468 | | | |
| Reflectance | Hunter UltraS-canPRO, | ASTM E 1331 with | | | |
| | diffuse/8°; D65; 10° | shine | | | |
| Sample thickness (ro) | | mm | 2 | 2 | 2 |
| L* (ro) | | | 98.27 | 98.29 | 98.35 |
| a* (ro) | | | −0.54 | −0.55 | −0.56 |
| b* (ro) | | | 2.13 | 2.11 | 2.11 |
| Reflectance (ro) | | % | 95.6 | 95.64 | 95.79 |
| Yellowness index (ro) | | | 3.53 | 3.48 | 3.49 |
| 60° Shine (ro) | | | 102 | 102 | 102 |

The addition of mica component C1 in E-26 leads to an increase in reflectance compared to V-25 which does not contain component C1.

1. A thermoplastic composition, containing
A) 44% by weight to 96.999% by weight of aromatic polycarbonate,
B) 3.0% by weight to 30.0% by weight of titanium dioxide, and
C) metal oxide-coated mica,
wherein
an amount of component C is 0.001% by weight to 0.15% by weight,
wherein reported amounts are in each case based on the total weight of the thermoplastic composition.

2. The thermoplastic composition as claimed in claim 1, wherein a D50 value of component C, determined using laser diffractometry on an aqueous slurry of the mica, is 1 to 100 μm.

3. The thermoplastic composition as claimed in claim 1, wherein a D50 value of component C, determined using laser diffractometry on an aqueous slurry of the mica, is 4.5 to 22.0 μm.

4. The thermoplastic composition as claimed in claim 1, wherein a metal oxide coating of the metal oxide-coated mica is a titanium dioxide coating.

5. The thermoplastic composition as claimed in claim 4, wherein a proportion of titanium dioxide in the titanium dioxide coating, based on the total weight of component C, is 25% to 50% by weight.

6. The thermoplastic composition as claimed in claim 1, wherein the aromatic polycarbonate present is exclusively bisphenol A-based polycarbonate.

7. The thermoplastic composition as claimed in claim 1, consisting of
A) 44.9% by weight to 95.996% by weight of aromatic polycarbonate,
B) 4.0% by weight to 25% by weight of titanium dioxide,
C) 0.004% by weight to 0.1% by weight of metal oxide-coated mica,
D) 0% to 30% by weight of one or more further additives(s) distinct from components B and C,
E) optionally one or more blend partners,
wherein the reported amounts are in each case based on the total weight of the thermoplastic composition.

8. The thermoplastic composition as claimed in claim 1, consisting of
A) 64.9% by weight to 95.996% by weight of aromatic polycarbonate,
B) 4.0% by weight to 25% by weight of titanium dioxide,
C) 0.004% by weight to 0.1% by weight of metal oxide-coated mica,
D) 0% to 10% by weight of one or more further additives(s) distinct from components B and C,
wherein the reported amounts are in each case based on the total weight of the thermoplastic composition.

9. The thermoplastic composition as claimed in claim 1, containing 0.006% by weight to 0.010% by weight of component C.

10. The thermoplastic composition as claimed in claim 1, consisting of
A) 76.99% by weight to 94.994% by weight of aromatic polycarbonate,
B) 5% by weight to 20% by weight of titanium dioxide,
C) 0.006% by weight to 0.010% by weight of metal oxide-coated mica,
D) 0% to 3% by weight of one or more further additives(s) distinct from components B and C,
wherein the reported amounts are in each case based on the total weight of the thermoplastic composition.

11. The thermoplastic composition as claimed in claim 1, wherein at least one additive from the group of heat stabilizers, flame retardants, impact modifiers and transesterification inhibitors is present in the thermoplastic composition as a further additive.

12. A molded part made of a thermoplastic composition as claimed in claim 1.

13. The molded part as claimed in claim 12, wherein the molded part is a reflector or part of a reflector.

14. A method for improving a reflectance of a titanium dioxide-containing polycarbonate composition comprising providing thereto a metal oxide-coated mica.

15. The method as claimed in claim 14, wherein provision of the metal oxide-coated mica also improves a yellowness index of the titanium dioxide-containing polycarbonate composition.
